(19) United States
(12) Patent Application Publication
(10) Pub. No.: US 2010/0250316 A1
(43) Pub. Date: Sep. 30, 2010

(54) DEVELOPING A SERVICE ORIENTED ARCHITECTURE SHARED SERVICES PORTFOLIO

(75) Inventors: Kishore Channabasavaiah, Palatine, IL (US); Pranav Jhumkhawala, Fremont, CA (US); Sri Ramanathan, Lutz, FL (US); Matthew B. Trevathan, Kennesaw, GA (US); Raghu Varadan, San Francisco, CA (US); Nevenco Zunic, Hopewell Junction, NY (US)

Correspondence Address: Keohane & D'Alessandro, 1881 Western Avenue Suite 180, Albany, NY, 12203, US

(73) Assignee: International Business Machines Corporation, Armonk, NY (US)

(21) Appl. No.: 12/411,460

(22) Filed: Mar. 26, 2009

(51) Int. Cl. G06Q 10/00

(52) U.S. Cl. 705/8; 705/7

(57) ABSTRACT

An approach that develops a service oriented architecture (SOA) shared services portfolio is provided. In one embodiment, there is a portfolio tool, including a decomposition component configured to decompose a business architecture of an enterprise into a set of SOA shared services, and a development component configured to develop a SOA shared service portfolio that is populated with the set of SOA shared services.

### FIELD OF THE INVENTION

This invention relates generally to lifecycle management and more specifically to the lifecycle management of SOA shared services.

### BACKGROUND OF THE INVENTION

In the past, software architectures have attempted to deal with increasing levels of software complexity. As the level of complexity continues to increase, traditional architectures are reaching the limit of their ability to deal with various problems. At the same time, traditional needs of information technology (IT) organizations persist. IT organizations need to respond quickly to new requirements of the business, while continuing to reduce the cost of IT to the business by absorbing and integrating new business partners, new business sets, etc.

Deconstructing and understanding business architectures to successfully deliver enterprise services is a complex undertaking for all businesses. Currently, no structured formal approach having a well-defined repeatable methodology based on the overall framework exists. There are no known standardized frameworks available in the industry that provide guidance and structure to such decomposition efforts to enable enterprises to undertake such initiatives with confidence.

### SUMMARY OF THE INVENTION

In one embodiment, there is a method for developing a service oriented architecture (SOA) shared services portfolio. In this embodiment, the method comprises: decomposing a business architecture of an enterprise into a set of SOA shared services; and developing a SOA shared services portfolio that is populated with the set of SOA shared services.

In a second embodiment, there is a system for developing a service oriented architecture (SOA) shared services portfolio. In this embodiment, the system comprises at least one processing unit, and memory operably associated with the at least one processing unit. A portfolio tool is storable in memory and executable by the at least one processing unit. The portfolio tool comprises: a decomposition component configured to decompose a business architecture of an enterprise into a set of SOA shared services; and a development component configured to develop a SOA shared service portfolio that is populated with the set of SOA shared services.

In a third embodiment, there is a computer-readable medium storing computer instructions, which when executed, enables a computer system to develop a service oriented architecture (SOA) shared services portfolio, the computer instructions comprising: decomposing a business architecture of an enterprise into a set of SOA shared services; and developing a SOA shared services portfolio that is populated with the set of SOA shared services.

In a fourth embodiment, there is a method for deploying a portfolio tool for use in a computer system that provides development of a service oriented architecture (SOA) shared services portfolio. In this embodiment, a computer infrastructure is provided and is operable to: decompose a business architecture of an enterprise into a set of SOA shared services; and develop a SOA shared services portfolio that is populated with the set of SOA shared services.

### BRIEF DESCRIPTION OF THE DRAWINGS

FIG. 1 shows a schematic of an exemplary computing environment in which elements of the present invention may operate;

FIG. 2 shows a flow diagram of a SOA services lifecycle management process;

FIG. 3 shows a portfolio tool that operates in the environment shown in FIG. 1; and

FIG. 4 shows a flow diagram of a method for developing and managing a SOA shared services portfolio according to embodiments of the invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

Embodiments of this invention are directed to developing a service oriented architecture (SOA) shared services portfolio. In these embodiments, a portfolio tool provides this capability. Specifically, the portfolio tool comprises a decomposition component configured to decompose a business architecture of an enterprise into a set of SOA shared services; and a development component configured to develop a SOA shared service portfolio that is populated with the set of SOA shared services.

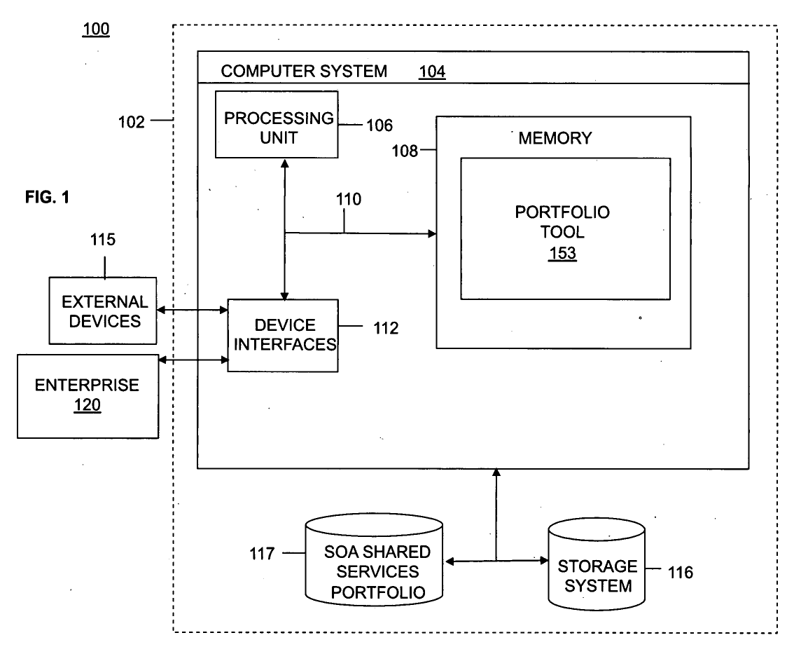

FIG. 1 illustrates a computerized implementation 100 of the present invention. As depicted, implementation 100 includes computer system 104 deployed within a computer infrastructure 102. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 102 is intended to demonstrate that some or all of the components of implementation 100 could be deployed, managed, serviced, etc., by a service provider who offers to implement, deploy, and/or perform the functions of the present invention for others.

Computer system 104 is intended to represent any type of computer system that may be implemented in deploying/realizing the teachings recited herein. In this particular example, computer system 104 represents an illustrative system for managing a SOA shared service. It should be understood that any other computers implemented under the present invention may have different components/software, but will perform similar functions. As shown, computer system 104 includes a processing unit 106, memory 108 for storing a portfolio tool 153, a bus 110, and device interfaces 112.

Processing unit 106 collects and routes signals representing outputs from external devices 115 (e.g., a keyboard, a pointing device, a display, a graphical user interface, etc.) to portfolio tool 153. The signals can be transmitted over a LAN and/or a WAN (e.g., T1, T3, 56 kb, X.25), broadband connections (ISDN, Frame Relay, ATM), wireless links (802.11, Bluetooth, etc.), and so on. In some embodiments, the signals may be encrypted using, for example, trusted key-pair encryption. Different external devices may transmit information using different communication pathways, such as Ethernet or wireless networks, direct serial or parallel connections, USB, Firewire®, Bluetooth®, or other proprietary interfaces. (Firewire is a registered trademark of Apple Computer, Inc. Bluetooth is a registered trademark of Bluetooth Special Interest Group (SIG)).

In general, processing unit 106 executes computer program code, such as program code for operating portfolio tool 153, which is stored in memory 108 and/or storage system 116. While executing computer program code, processing unit 106 can read and/or write data to/from memory 108, storage system 116, and a SOA shared services registry 117. SOA shared services registry 117 stores a plurality of SOA shared services and associated metadata, as well as rules against which the metadata is compared to locate, update, and store SOA shared services from decomposed business architectures, as will be further described below. Storage system 116 and services registry 117 can include VCRs, DVRs, RAID arrays, USB hard drives, optical disk recorders, flash storage devices, or any other similar storage device. Although not shown, computer system 104 could also include I/O interfaces that communicate with one or more external devices 115 that enable a user to interact with computer system 104.

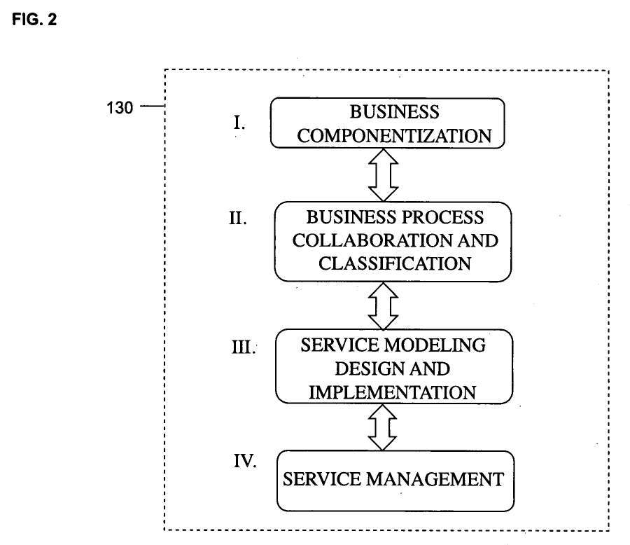

Implementation 100 and portfolio tool 153 operate within a broader SOA shared services and lifecycle management process (SSLMP) 130, shown in FIG. 2, which identifies, evaluates, implements, and manages a SOA shared service. SOA SSLMP 130 provides guidance for decomposing a business architecture 132 of an enterprise 120 and managing the entire lifecycle of a shared service(s) within an enterprise. Specifically, SOA SSLMP 130 of the present invention includes new and distinct roles, governance checkpoints, increased collaboration requirements, and new decision control points. SOA SSLMP 130 takes an extended view in identifying the various touch-points inside and outside of the organization to plan, build and manage shared services within a SOA shared services portfolio. SOA SSLMP 130 defines a framework for shared services governance and lifecycle management that provides a formal approach and structure to enable the decomposition of business architectures to define, design, implement and manage an enterprise services portfolio. This framework allows enterprises to define or leverage existing processes and methodologies to decompose business architectures to deliver a comprehensive portfolio of enterprise services.

SOA SSLMP 130 of the present invention consists of the following distinct processes and associated methodologies:
I. Business Componentization—the goal of this phase is to detail the business processes of the business architecture based on the overall business goals and operational aspects of the business as a whole. This phase addresses the requirements of shared services portfolio planning, prioritization, including ownership prioritization, cross business domain interdependencies and identified high-value business services.
II. Business Process Collaboration and Classification—the goal of this phase is to identify business processes at all levels of an enterprise. This phase analyzes business components/processes and identifies cross-functional business services.
III. Service Modeling Design and Implementation—the goal of this phase is to gather elements of the framework necessary for the definition, design, and implementation of the SOA shared services portfolio based on the decomposed business architectures and business processes.
IV. Service Management—the goal of this phase is to evaluate and mature the SOA shared services within the SOA shared services portfolio based on an established plan that is focused on collaboration, program planning and funding.

Each of the above processes is a complete methodology that can be implemented independently since they define key stakeholders, affected processes, and touch-points throughout the organization. It will be appreciated that each of the above listed SOA processes are non-limiting examples of the functionality and operation of possible implementations of systems, methods and computer program products according to various embodiments of the present invention. In this regard, each process (I-VIII) may represent a module, segment, or portion of code, which comprises one or more executable instructions for implementing the specified logical function(s) of SOA SSLMP 130, as shown in FIG. 2. It should also be noted that, in some alternative implementations, the functions noted in SOA SSLMP 130 may occur out of the order listed above in processes I-VIII. For example, two phases shown in FIG. 2 in succession may, in fact, be executed substantially concurrently. It should also be noted that, in another alternative embodiment, additional or fewer process steps may be included in SOA SSLMP 130. Further, each process of the flowchart of FIG. 2 can be implemented by special purpose hardware-based systems that perform the specified functions or acts, or combinations of special purpose hardware and computer instructions.

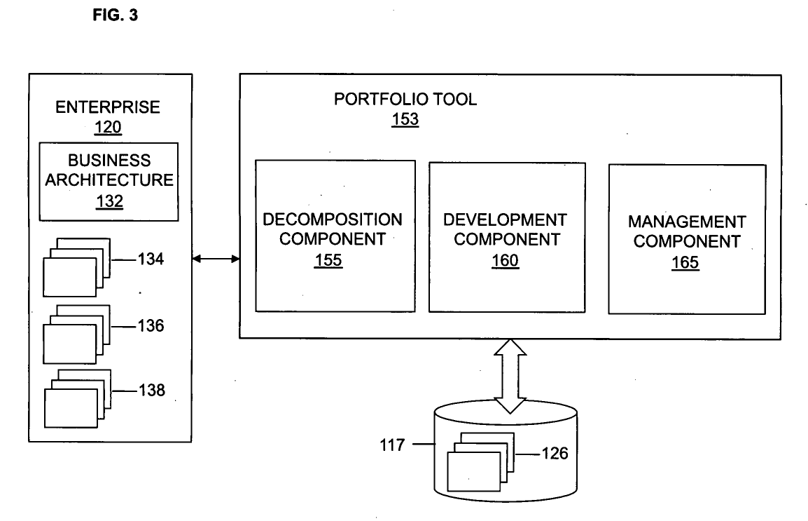

Referring now to FIG. 3, a more detailed view of portfolio tool 153, which develops SOA shared service portfolio 117, will be provided. As shown, portfolio tool 153 comprises a decomposition component 155 configured to decompose a business architecture 132 of enterprise 120 (e.g., a business or business unit) into a set of SOA shared services 126. Specifically, in one embodiment, decomposition component 155 is configured to identify a set of business objectives 134 of enterprise 120, identify a set of operational requirements 136 of enterprise 120, and identify a set of business processes 138 based on set of business objectives 134 of enterprise 120 and set of operational requirements 136 of enterprise 120. In this way, business architecture 132 is broken-down, analyzed, and re-structured in to organize the various services of enterprise 120. Decomposition component 155 simplifies portfolio planning in terms of ownership prioritization, cross business domain interdependencies, high-value business services, etc.

Next, once business architecture 132 is decomposed, a comprehensive portfolio of enterprise services is created. To accomplish this, a development component 160 is configured to develop SOA shared services portfolio 117 that is populated with set of SOA shared services 126. As mentioned above, SOA shared services portfolio 117 stores set of SOA shared services 126 and associated metadata, as well as rules against which the metadata is compared to locate, update, and store SOA shared services from decomposed business architecture 132.

In one embodiment, SOA shared services portfolio 117 is developed as described in phase 11 of SOA SSMLP 130 (FIG. 2). The Business Process Collaboration and Classification phase of SOA SSMLP 130 identifies, evaluates, and leverages business processes at varying levels of granularity (i.e., specificity). To accomplish this, development component 160 is configured to establish interdependencies between each of set of business processes 138. Development component 160 analyzes the prioritized business processes and collaborative business components to identify cross-functional business services, as well as their cross-functional applicability and reusability potential.

Next, each of set SOA shared services 126 is modeled, for example as described in the Service Modeling Design and Implementation phase shown in FIG. 2. The Service Modeling, Design and Implementation phase of SOA SSMLP 130 includes aspects necessary for the definition, design and implementation of SOA shared services portfolio 117 based on the decomposed business architectures and business processes. The processes and methodologies that enable the design and delivery of SOA shared services portfolio 117 are configured to leverage the outputs of the Business Componentization and Business Process Collaboration phase to enable a seamless leverage of the overall lifecycle process. In one embodiment, to accomplish this, development component 160 is configured to establish set of SOA shared services 126 based on the interdependencies between each of set of set of business processes 138.

After SOA shared services portfolio 117 is established and populated with set of SOA shared services 126, it is beneficial to manage/monitor SOA shared services portfolio 117 to maintain continuing service offerings and performance. In one embodiment, to accomplish this, portfolio tool 153 comprises a management component 165 configured to manage SOA shared services portfolio 117 and set of SOA shared services 126. Management component 165 manages aspects of service configuration, service re-factoring, service evolution, and service phase-out that are essential for the governance and lifecycle management of SOA shared services. The processes and methodologies identified for shared services portfolio re-factoring focus on establishing and maturing the services in terms of collaborations, program planning and funding. Service management helps enterprise 120 understand the entire lifecycle of a service and its impact on the enterprise.

Further, it can be appreciated that the methodologies disclosed herein can be used within a computer system to provide management of a SOA shared service, as shown in FIG. 1. In this case, portfolio tool 153 can be provided, and one or more systems for performing the processes described in the invention can be obtained and deployed to computer infrastructure 102. To this extent, the deployment can comprise one or more of (1) installing program code on a computing device, such as a computer system, from a computer-readable medium; (2) adding one or more computing devices to the infrastructure; and (3) incorporating and/or modifying one or more existing systems of the infrastructure to enable the infrastructure to perform the process actions of the invention.

The exemplary computer system 104 may be described in the general context of computer-executable instructions, such as program modules, being executed by a computer. Generally, program modules include routines, programs, people, components, logic, data structures, and so on that perform particular tasks or implements particular abstract data types. Exemplary computer system 104 may be practiced in distributed computing environments where tasks are performed by remote processing devices that are linked through a communications network. In a distributed computing environment, program modules may be located in both local and remote computer storage media including memory storage devices.

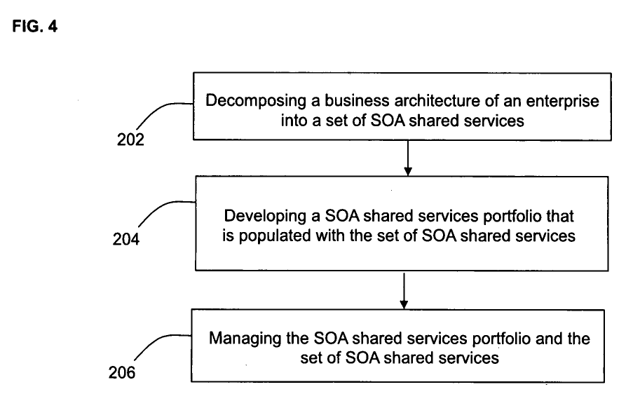

The program modules carry out the methodologies disclosed herein, as shown in FIG. 4. According to one embodiment, at 202, a business architecture of an enterprise is decomposed into a set of SOA shared services. At 204, a SOA shared services portfolio is developed and populated with the set of SOA shared services. At 206, the SOA shared services portfolio and the set of SOA shared services is managed. The flowchart of FIG. 4 illustrates the architecture, functionality, and operation of possible implementations of systems, methods and computer program products according to various embodiments of the present invention. In this regard, each block in the flowchart may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently. It will also be noted that each block of flowchart illustration can be implemented by special purpose hardware-based systems that perform the specified functions or acts, or combinations of special purpose hardware and computer instructions.

Furthermore, an implementation of exemplary computer system 104 may be stored on or transmitted across some form of computer readable media. Computer readable media can be any available media that can be accessed by a computer. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

It is apparent that there has been provided with this invention an approach for managing a SOA shared service. While the invention has been particularly shown and described in conjunction with a preferred embodiment thereof, it will be appreciated that variations and modifications will occur to those skilled in the art. Therefore, it is to be understood that the appended claims are intended to cover all such modifications and changes that fall within the true spirit of the invention.

What is claimed is:

1. A method for developing a service oriented architecture (SOA) shared services portfolio comprising:
decomposing a business architecture of an enterprise into a set of SOA shared services; and
developing a SOA shared services portfolio that is populated with the set of SOA shared services.

2. The method according to claim 1 further comprising managing the SOA shared services portfolio and the set of SOA shared services.

3. The method according to claim 1, the decomposing comprising:
identifying a set of business objectives of the enterprise;
identifying a set of operational requirements of the enterprise; and
identifying a set of business processes based on the set of business objectives of the enterprise and the set of operational requirements of the enterprise.

4. The method according to claim 3, the developing comprising:
establishing interdependencies between each of the set of business processes.

5. The method according to claim 4, the developing further comprising establishing the set of SOA shared services based on the interdependencies between each of the set of business processes.

6. A system for developing a service oriented architecture (SOA) shared services portfolio comprising:
at least one processing unit;
memory operably associated with the at least one processing unit; and
a portfolio tool storable in memory and executable by the at least one processing unit, the portfolio tool comprising:
a decomposition component configured to decompose a business architecture of an enterprise into a set of SOA shared services; and
a development component configured to develop a SOA shared services portfolio that is populated with the set of SOA shared services.

7. The portfolio tool according to claim 6, further comprising a management component configured to manage the SOA shared services portfolio and the set of SOA shared services.

8. The portfolio tool according to claim 6, the decomposition component further configured to:
identify a set of business objectives of the enterprise;
identify a set of operational requirements of the enterprise; and
identify a set of business processes based on the set of business objectives of the enterprise and the set of operational requirements of the enterprise.

9. The portfolio tool according to claim 8, the development component further configured to establish interdependencies between each of the set of business processes.

10. The portfolio tool according to claim 9, the development component further configured to establish the set of SOA shared services based on the interdependencies between each of the set of business processes.

11. A computer-readable medium storing computer instructions, which when executed, enables a computer system to develop a service oriented architecture (SOA) shared services portfolio, the computer instructions comprising:
decomposing a business architecture of an enterprise into a set of SOA shared services; and
developing a SOA shared services portfolio that is populated with the set of SOA shared services.

12. The computer-readable medium according to claim 11, the computer instructions further comprising managing the SOA shared services portfolio and the set of SOA shared services.

13. The computer-readable medium according to claim 11, the computer instructions for decomposing further comprising:
identifying a set of business objectives of the enterprise;
identifying a set of operational requirements of the enterprise; and
identifying a set of business processes based on the set of business objectives of the enterprise and the set of operational requirements of the enterprise.

14. The computer-readable medium according to claim 13, the computer instructions for developing further comprising establishing interdependencies between each of the set of business processes.

15. The computer readable medium according to claim 14, the computer instructions for developing further comprising establishing the set of SOA shared services based on the interdependencies between each of the set of business processes.

16. A method for deploying a portfolio tool for use in a computer system that provides development of a service oriented architecture (SOA) shared services portfolio, comprising:
providing a computer infrastructure operable to:
decompose a business architecture of an enterprise into a set of SOA shared services; and
develop a SOA shared services portfolio that is populated with the set of SOA shared services.

17. The method according to claim 16, the computer infrastructure further operable to manage the SOA shared services portfolio and the set of SOA shared services.

18. The method according to claim 16, the computer infrastructure operable to decompose further operable to:
identify a set of business objectives of the enterprise;
identify a set of operational requirements of the enterprise; and
identify a set of business processes based on the set of business objectives of the enterprise and the set of operational requirements of the enterprise.

19. The method according to claim 18, the computer infrastructure operable to develop further operable to establish interdependencies between each of the set of business processes.

20. The method according to claim 19, the computer infrastructure operable to develop further operable to establish the set of SOA shared services based on the interdependencies between each of the set of business processes.
